(19) United States
(12) Patent Application Publication
(10) Pub. No.: US 2025/0218436 A1
(43) Pub. Date: Jul. 3, 2025

(54) Local Voice Recognition and Processing Within a Head Worn Device

(71) Applicant: 3M INNOVATIVE PROPERTIES COMPANY, St. Paul, MN (US)

(72) Inventors: William B. Howell, Pineville, NC (US); Darin K. Thompson, Huntersville, NC (US); Richard J. Sabacinski, Charlotte, NC (US); Traian Morar, Matthews, NC (US)

(21) Appl. No.: 18/850,247

(22) PCT Filed: Mar. 17, 2023
(86) PCT No.: PCT/IB2023/052655

§ 371 Date: Sep. 24, 2024

Related U.S. Application Data
(60) Provisional application No. 63/327,211, filed on Apr. 4, 2022.

(51) Int. Cl. G10L 15/22; G06F 1/16; G10L 15/18

(52) U.S. Cl. CPC G10L 15/22; G06F 1/163; G10L 15/1815

(57) ABSTRACT

A head worn device configured to be worn by a user is provided. The head worn device includes at least one microphone and processing circuitry configured to receive an audio signal detected by the at least one microphone, wherein the audio signal represents the user's speech. The processing circuitry is configured to evaluate the received audio signal and determine at least one intent based on the received audio signal. The evaluating and determining are performed by the processing circuitry. The processing circuitry is configured to perform at least one action based on the determined intent.

### TECHNICAL FIELD

This disclosure relates to voice recognition, and in particular to an apparatus and system, and related methods of use thereof, for local voice recognition and processing within a head worn device.

### INTRODUCTION

When wearing personal protective equipment (PPE), such as a full face respirator, turnout gear, thick gloves, helmet, etc., it may be challenging for a first responder to find and press small buttons and receive feedback of the mechanical button actuation. Along with this difficulty, first responders typically must carry equipment and as such may not have a free hand for operating additional electronics. Further, it may not be feasible to rely on remote/cloud-based processing of voice recognition commands due to connectivity constraints and/or time constraints in an emergency environment/situation.

### SUMMARY

The present disclosure describes implementing local processing of voice recognition of voice commands for a first responder's head worn equipment to actuate electronics for communications, status checks, etc., for improved safety and user experience.

Some embodiments advantageously provide a method and system for a head worn device configured to be worn by a user. The head worn device includes at least one microphone and processing circuitry in communication with the at least one microphone configured to receive an audio signal detected by the at least one microphone, wherein the audio signal represents the user's speech. The processing circuitry is configured to evaluate the received audio signal and determine at least one intent based on the received audio signal. The evaluating and determining is performed by the processing circuitry. The processing circuitry is configured to perform at least one action based on the determined intent.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 is a schematic diagram of various devices and components according to some embodiments of the present invention;

FIG. 2 is a block diagram of an example head worn device according to some embodiments of the present invention; and

FIG. 3 is a flowchart of an example process in a head worn device according to some embodiments of the present invention.

### DETAILED DESCRIPTION

Before describing in detail exemplary embodiments, it is noted that the embodiments reside primarily in combinations of apparatus components and processing steps related to local voice recognition and processing within a head worn device for a first responder. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

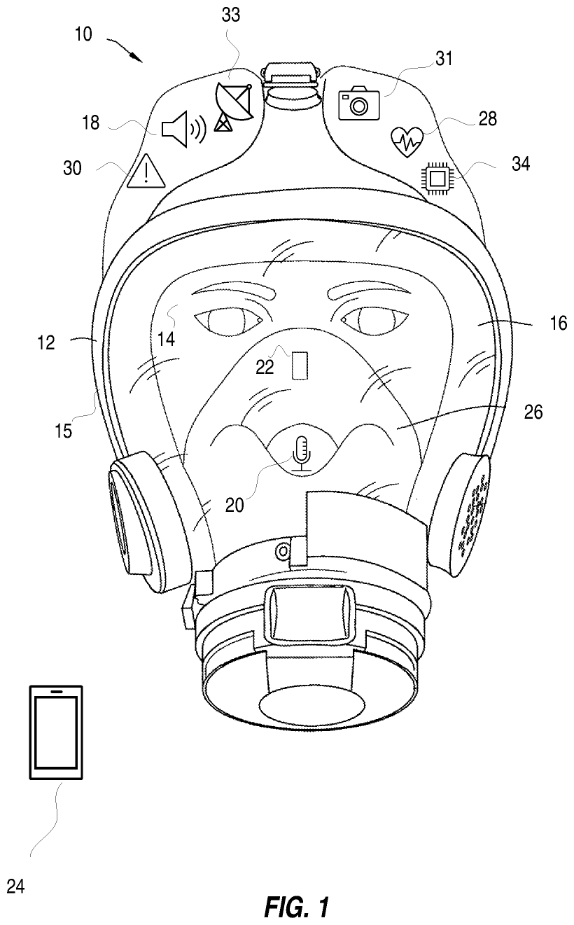

Referring now to the drawing figures, in which like reference designators refer to like elements, FIG. 1 shows an embodiment of a voice recognition system 10 which utilizes a head worn device 12 worn by user 14, which may include a mask body 15 and lens 16. In some embodiments, head worn device 12 may be a mask, such as a mask that is part of a respirator and/or self-contained breathing apparatus (SCBA) such as the type worn by a first responder. Head worn device 12 may include speaker 18, e.g., integrated into head worn device 12 and/or mask body 15, for providing audio indications/messages to user 14, and may include microphone 20, e.g., integrated into head worn device 12, for receiving spoken commands from user 14. Head worn device 12 may include a display 22, e.g., integrated into lens 16, for providing visual indications/messages to user 14 of head worn device 12. Microphone 20 may be configured to detect audio signals, e.g., spoken commands from user 14 of head worn device 12.

Voice recognition system 10 may include additional equipment 24 worn/held by user 14 (e.g., an air pack worn by a firefighter user 14), which may be in communication with head worn device 12, e.g., via a wired/wireless connection. Additional equipment 24 may include the same or similar components as head worn device 12, including, e.g., processing circuitry, a microphone, a speaker, a communication interface, etc.

Head worn device 12 may include a mechanical, at least partially sound isolating, mechanical barrier 26 for preventing the microphone 20 from receiving sound other than spoken utterances from user 14. For example, the mechanical barrier 26 may prevent microphone 20 from inadvertently receiving speech of other people in the vicinity of user 14. Mechanical barrier 26 may define a cavity including the at least one microphone 20 and the user 14's mouth when the head worn device is worn by user 14, e.g., to enhance the quality of audio detected from user 14's speech while minimizing detection of audio originating from outside the cavity, such as speech from other people in the vicinity of user 14, noise in the environment, etc. Alternatively, or additionally, microphone 20 and/or head worn device 12 may utilize electronic signal processing and/or filtering to avoid voice recognition of other sounds (i.e., sounds which are not originating from user 14 speaking into microphone 20), as described herein.

Head worn device 12 may include biometric sensor array 28, which may be configured to measure biometrics of user 14, e.g., heart rate, blood oxygen level, blood pressure, alertness level, etc., as described herein.

Head worn device 12 may include haptic feedback generator 30, e.g., for generating a vibrating alert that may be sensed by user 14, as described herein.

Head worn device 12 may include an image sensor 31, e.g., integrated into head worn device 12 and/or mask body 15, for capturing one or more images (e.g., of the environment, of user 14, etc.), as described herein.

Head worn device 12 may include communication interface 33, e.g., integrated into head worn device 12 and/or mask body 15, for establishing and maintaining a wired and/or wireless connection with another device of voice recognition system 10 and/or with another device and/or network external to voice recognition system 10, as described herein.

Head worn device 12 may include processing circuitry 34, e.g., integrated into head worn device 12 and/or mask body 15, which may be configured to control any of the methods and/or processes described herein and/or to cause such methods, and/or processes to be performed, e.g., by head worn device 12.

Microphone 20 may be implemented by any device, either standalone or part of head worn device 12 and/or user interface 48, that is configurable for detecting spoken commands by user 14 while user 14 is wearing head worn device 12. Microphone 20 may include local processing/filtering to aid in filtering out sounds other than user 14's spoken utterances. Microphone 20 may be affixed to/positioned in head worn device 12 (e.g., within a sealed region defined by mechanical barrier 26), such that mechanical barrier 26 may aid in preventing outside noise/voices/speech from being detected by microphone 20 and/or improving sound quality of audio detected by microphone 20 and/or ensuring that only user 14's voice recognition commands are detected.

Although FIG. 1 shows a single microphone 20, it is understood that implementations are not limited to one set of one microphone, and that there can be different numbers of sets of microphones, each having different quantities of individual microphones, without deviating from the scope of the present disclosure. Although FIG. 1 shows a single speaker 18, it is understood that implementations are not limited to one set of one speaker, and that there can be different numbers of sets of speakers, each having different quantities of individual speakers, without deviating from the scope of the present disclosure.

In some embodiments, speaker 18 and/or microphone 20 may be a bone conduction device (e.g., headset/headphone).

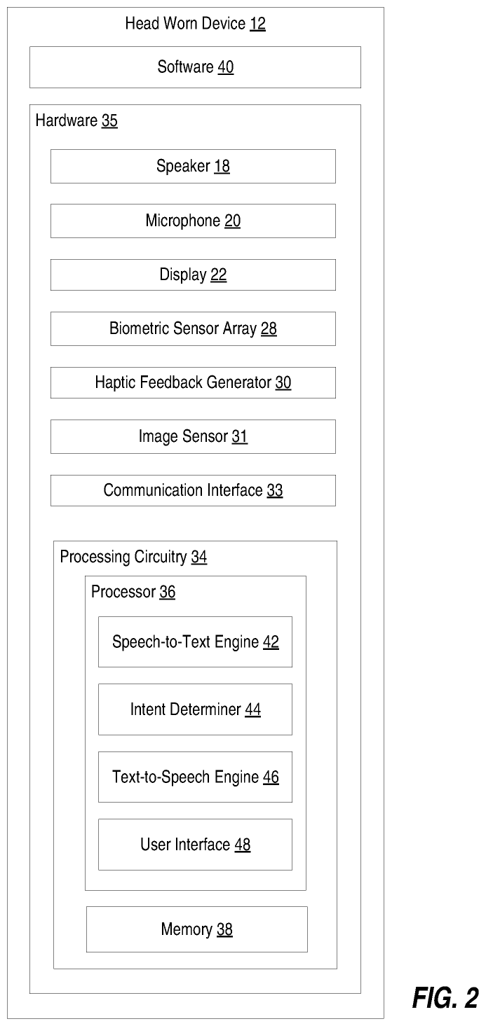

Referring now to FIG. 2, head worn device 12 may include hardware 35, including speaker 18, microphone 20, display 22, biometric sensor array 28, haptic feedback generator 30, image sensor 31, communication interface 33, and processing circuitry 34. The processing circuitry 34 may include a processor 36 and a memory 38. In addition to, or instead of a processor, such as a central processing unit, and memory, the processing circuitry 34 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 36 may be configured to access (e.g., write to and/or read from) the memory 38, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Hardware 35 may be removable from the mask body 15 to allow for replacement, upgrade, etc., or may be integrated as part of the head worn device 12.

Head worn device 12 may further include software 40 stored internally in, for example, memory 38 or stored in external memory (e.g., database, storage array, network storage device, etc.) accessible by head worn device 12 via an external connection. In some embodiments, the software 40 may be and/or may include firmware. The software 40 may be executable by the processing circuitry 34. The processing circuitry 34 may be configured to control any of the methods and/or processes described herein and/or to cause such methods, and/or processes to be performed, e.g., by head worn device 12. Processor 36 corresponds to one or more processors 36 for performing head worn device 12 functions described herein. The memory 38 is configured to store data, programmatic software code and/or other information described herein. In some embodiments, the software 40 may include instructions that, when executed by the processor 36 and/or processing circuitry 34, causes the processor 36 and/or processing circuitry 34 to perform the processes described herein with respect to head worn device 12. For example, head worn device 12 may include speech-to-text (STT) engine 42 configured to perform one or more head worn device 12 functions as described herein, such as transcribing user 14's speech (e.g., generating a string of text representing user 14's speech), e.g., based on processing of audio signals detected by microphone 20, as described herein.

Processing circuitry 34 of the head worn device 12 may include intent determiner 44 configured to perform one or more head worn device 12 functions as described herein such as determining the intent of user 14 based on a transcribed speech generated by STT engine 42, as described herein. Processing circuitry 34 of head worn device 12 may include text-to-speech (TTS) engine 46, configured to perform one or more head worn device 12 functions as described herein such as generating/synthesizing a spoken audio response/command/message/alert/etc. to be played for user 14, e.g., via speaker 18, as described herein. Processing circuitry 34 of head worn device 12 may include user interface 48 configured to perform one or more head worn device 12 functions as described herein such as displaying (e.g., using display 22) or announcing (e.g., using speaker 18) indications/messages to user 14, such as indications regarding the transcription generated by STT engine 42, the intent generated by intent determiner 44, the output generated by TTS engine 46, status/readings from biometric sensor array 28 (e.g., displaying the user 14's heart rate), status/notifications generated by other components/sub-systems of head worn device 12 and/or additional equipment 24, and/or receiving spoken commands from user 14 (e.g., using microphone 20) and/or receiving other commands from user 14 (e.g., user 14 presses a button in communication with the processing circuitry 34), and/or from other users (e.g., via a remote server which communicates with the processing circuitry 34 via communication interface 33), as described herein.

Speaker 18 may be implemented by any device, either standalone or part of head worn device 12, that is configurable for generating sound that is audible to user 14 while wearing head worn device 12, and is configurable for announcing (e.g., using speaker 18) indications/messages to user 14, such as indications regarding the requested command determined by intent determiner 44. In some embodiments, speaker 18 is configured to provide audio messages corresponding to the indications described above with respect to display 22, e.g., by playing synthesized speech generated by TTS engine 46.

Display 22 may be implemented by any device, either standalone or part of head worn device 12 and/or user interface 48, that is configurable for displaying indications/messages to user 14, e.g., indications regarding a voice recognition command received from user 14 and/or indications regarding the status of head worn device 12 and/or user 14. In some embodiments, display 22 may be configured to display a text message and/or icon indicating the speech transcribed by STT engine 42 and/or the intent generated by intent determiner 44. For example, if a user 14 utters a voice command (e.g., “Take a snapshot picture”), microphone 20 may detect the audio, and may send the audio (which may be processed/filtered by microphone 20 and/or other circuitry, such as processing circuitry 34) to STT engine 42. STT engine 42 may determine that the user has uttered the string “Take a snapshot picture”, and provides that string to intent determiner 44. Intent determiner 44 parses the string to determine that user 14 desires to execute the “Take snapshot picture” command, which may be one of several available commands of head worn device 12, and causes image sensor 31 to capture one or more images (e.g., of the environment, of user 14, etc.). Intent determiner 44 and/or processing circuitry 34 may instruct user interface 48 and/or display 22 to display a message/icon associated with the “Take snapshot picture” routine, such as a camera icon, a message indicating that the photograph was successfully taken (i.e., by image sensor 31), a thumbnail/preview of the captured image, etc.

Biometric sensor array 28 may be implemented by any device, either standalone or part of head worn device 12, that is configurable for detecting biometrics of user 14, such as body temperature, heart rate, blood oxygen level, etc.

Haptic feedback generator 30, may be implemented by any device, either standalone or part of head worn device 12, that is configurable for generating haptic feedback, such as an actuator that creates a vibration, which may be sensed by user 14.

Image sensor 31 may be implemented by any device, either standalone or part of head worn device 12, that is configurable for detecting images, such as images of user 14's face and/or images of the surrounding environment of user 14. Image sensor 31 may include multiple image sensors (e.g., co-located and/or mounted at different locations on head worn device 12 and/or on other devices/equipment in communication with head worn device 12 via communication interface 33), or may include a single image sensor. Image sensor 31 may include a thermal imaging sensor/camera.

Communication interface 33 may include a radio interface configured to establish and maintain a wireless connection (e.g., with a remote server via a public land mobile network, with a hand-held device, such as a smartphone, with other head worn devices 12, etc.). The radio interface may be formed as, or may include, for example, one or more radio frequency, RF transmitters, one or more RF receivers, and/or one or more RF transceivers. Communication interface 33 may include a wired interface configured to set up and maintain a wired connection (e.g., an ethernet connection, universal serial bus connection, etc.). In some embodiments, head worn device 12 may send, via the communication interface 33, sensor readings and/or data (e.g., image data, audio data, calibration data, intent data, etc.) from one or more of speaker 18, microphone 20, display 22, biometric sensor array 28, haptic feedback generator 30, image sensor 31, communication interface 33, and processing circuitry 34 to additional head worn devices 12 (not shown), additional equipment 24, and/or remote servers (e.g., an incident command server, not shown). In some embodiments, communication interface 33 may be configured to wirelessly communicate with other nearby head worn devices 12, e.g., via a mesh network.

In some embodiments, user interface 48 and/or display 22 may be a heads up display (HUD) and/or superimposed/augmented reality (AR) overlay, which may be configured such that user 14 of head worn device 12 may see through lens 16, and images/icons displayed on display 22 appear to user 14 of head worn device 12 as superimposed on the transparent/translucent field of view (FOV) through lens 16. In some embodiments, display 22 may be separate from lens 16. Display 22 may be implemented using a variety of techniques known in the art, such as a liquid crystal display built into lens 16, an optical head-mounted display built into head worn device 12, a retinal scan display built into head worn device 12, etc.

In some embodiments, STT engine 42 may generate a transcription/string of user 14's verbal utterances/speech (e.g., detected by microphone 20) using a variety of techniques known in the art. In some embodiments, STT engine 42 may utilize a machine learning model, e.g., stored in memory 38, to improve the accuracy of speech transcription. In some embodiments, STT engine 42 may improve based on data collected from user 14, e.g., during a calibration procedure in which user 14 recites certain predetermined phrases, and/or during routine usage of head worn device 12, by collecting samples of user 14's speech over time. In some embodiments, STT engine 42 may generate the transcription of user 14's speech without the use of any processing external to head worn device 12.

In some embodiments, STT engine 42 may be configured to perform a calibration procedure. For example, user 14 of head worn device 12 may initiate a calibration procedure, e.g., upon first use of the head worn device 12. The calibration procedure may include, for example, displaying calibration phrases on display 22 and/or playing audio samples of calibration phrases via speaker 18, instructing (e.g., using visual and/or audio commands via user interface 48) the user 14 to repeat the calibration phrases (e.g., by speaking into microphone 20), and adjusting one or more speech recognition parameters utilized by STT engine 42 based thereon. Other/additional calibration procedures may be used to improve the accuracy of STT engine 42, such as using machine learning (e.g., based on datasets of user 14's speech and/or speech of other users of head worn device 12). STT engine 42 may be configured to detect user 14's voice, e.g., as a result of the calibration procedure, so as to filter out other voices (e.g., speakers in the vicinity of user 14), in addition to/as an alterative to filtering out outside noise/voices using mechanical barrier 26 and/or other filtering/audio processing performed by microphone 20.

STT engine 42 may use any technique known in the art for transcribing the speech of user 14 without deviating from the scope of the invention.

Intent determiner 44 may determine the intent of user 14 (e.g., of the command/utterance/speech spoken by user 14 as determined by STT engine 42) using a variety of techniques known in the art. In some embodiments, intent determiner 44 may perform natural language processing on the speech transcribed by STT engine 42, which may be used to determine the intent of user 14. In some embodiments, the string generated by STT engine 42 may be compared to a set of preconfigured commands. In some embodiments, intent determiner 44 may assign a probability score to each preconfigured command based on a comparison with the string generated by STT engine 42, and STT engine 42 may output the command with the highest probability score as the determined intent. In some embodiments, the probability scores may be based on a machine learning model, a neural network model, and/or other statistical techniques known in the art. Intent determiner 44 may be configured to generate a command/instruction/response based on the determined intent of user 14. In some embodiments, intent determiner 44 may determine the intent of user 14 voice command without the use of any processing external to head worn device 12.

Intent determiner 44 may use any technique known in the art for determining the intent of user 14's speech without deviating from the scope of the invention.

In some embodiments, TTS engine 46 may be configured to generate/synthesize speech based on the intent generated by intent determiner 44. For example, TTS engine 46 may be configured to recite a simple phrase, e.g., notifying user 14 of the command determined by intent determiner 44. TTS engine 46 may be configured to generate sentences and/or conversations with user 14, e.g., in order to collect additional information from user 14 and/or provide additional information to user 14, e.g., as part of a procedure initiated by intent determiner 44. In some embodiments, TTS engine 46 may synthesize speech without the use of any processing external to head worn device 12.

User interface 48 may be configured to instruct display 22 to display a message/icon associated with a routine, operation, mode, status, etc. of head worn device 12. User interface 48 may be configured to announce (e.g., using speaker 18) indications/messages to user 14, e.g., as generated by TTS engine 46. User interface 48 may be configured to provide alerts (e.g., a predefined series of vibrations/pulses) to user 14 using haptic feedback generator 30.

In some embodiments, head worn device 12 may be a respirator facepiece, mask, facemask, goggles, visor, and/or spectacles, and/or may be part of a SCBA.

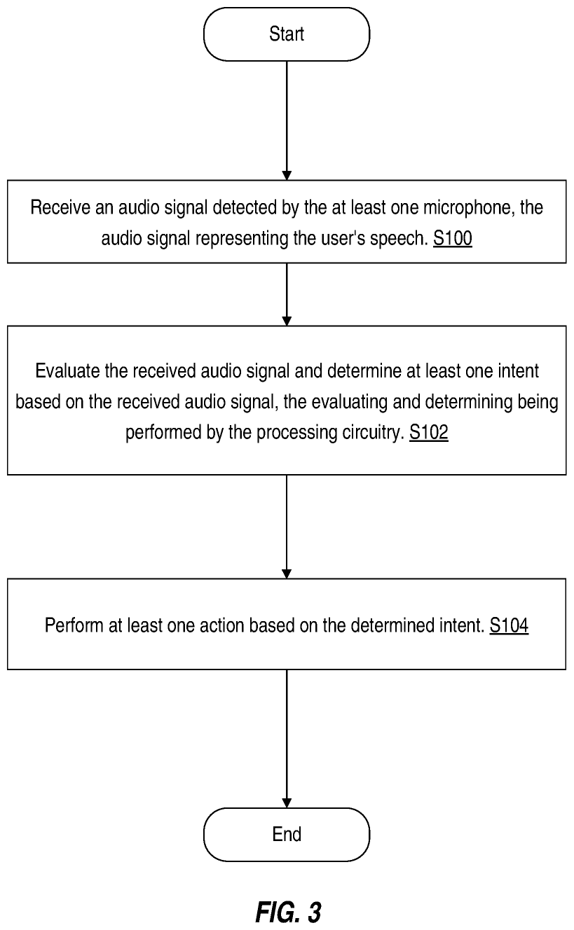

FIG. 3 is a flowchart of an example process in a head worn device 12 according to some embodiments of the invention. One or more blocks described herein may be performed by one or more elements of head worn device 12, such as by one or more of processing circuitry 34, speaker 18, microphone 20, display 22, biometric sensor array 28, haptic feedback generator 30, image sensor 31, communication interface 33, processor 36, memory 38, software 40, STT engine 42, intent determiner 44, TTS engine 46, and/or user interface 48. Head worn device 12 is configured to receive (Block S100) an audio signal detected by at least one microphone (e.g., microphone 20), wherein the audio signal represents the user 14's speech. Head worn device 12 is configured to evaluate (Block S102) the received audio signal and determine an intent based on the audio signal, wherein the evaluating and determining are performed by the processing circuitry 34. Head worn device is configured to perform (Block S104) at least one action based on the determined intent.

In some embodiments, the head worn device includes a mechanical barrier 26, the mechanical barrier 26 defining a cavity including the at least one microphone 20 and the user 14's mouth when head worn device is worn by user 14, the mechanical barrier 26 being configured to attenuate noise originating from outside the cavity.

The present disclosure describes a head worn device for a first responder with local-based voice recognition, where a microcontroller/processor/etc. (e.g., processing circuitry 34) receives verbal commands from user 14 and thereby processes the verbal command for further instructions/actions without requiring the use of outside processing (e.g., cloud-based services and/or a remote server). Embodiments of the present disclosure may process voice speech in multiple languages. Embodiments of the present disclosure may be used in various head worn devices 12, such as masks, facepieces, SCBAs, etc., such as those worn by first responders (e.g., the 3M™ Scott™ Vision C5 Facepiece). Embodiments of the present disclosure may control (e.g., based on voice commands uttered by user 14) information displayed on the head worn device 12 display 22, e.g., information/biometrics associated with head worn device 12 and/or information received via communication interface 33, such as a wired or wireless link to other equipment (e.g., additional equipment 24) worn/held by the user of the head worn device 12 and/or other head worn devices 12.

In some embodiments of the present disclosure, a microphone receiver (e.g., microphone 20) is contained inside the head worn device/facepiece (e.g., head worn device 12), such that the voice command is only received from user 14, i.e., using a mechanical barrier 26 to block/limit/attenuate outside noise/voices. In some embodiments, firmware/software/etc. (e.g., software 40) may be customizable to set minimum voice detection levels.

In some embodiments, voice command processing is locally processed, i.e., without the use of processing circuitry external to head worn device 12, such as a remote server, a cloud-based server, etc. Voice commands may trigger events such as: receiving and overlaying geometric plots (e.g., on display 22) for determining location through a wireless link (e.g., communication interface 33), relaying communications from and to other first responders, e.g., via a mesh network using communication interface 33, etc.

In some embodiments, the head worn device 12 includes firmware/software/etc. (e.g., software 40) to allow voice commands to be initiated during a purge procedure and/or during a vibration alert (“Vibralert”) end of service time indicator (EOSTI) procedure/mode, e.g., to filter out noise caused by these procedures. For example, in some embodiments, a purge mode, EOSTI mode, and/or Vibralert mode may cause the head worn device 12 to generate a large amount of audible noise and/or haptic noise. This may occur, for instance, when the first responder is running out of air and trying to escape from a dangerous situation. In some embodiments, head worn device 12 may be configurable to record and/or identify the noise/sound generated by the purge mode, EOTSI mode, Vibralert mode, or any other noise-generating component/alarm/function of voice recognition system 10, e.g., using microphone 20. In some embodiments, the head worn device 12 may be configurable to filter (e.g., using processing circuitry 34, which may be internal to the head worn device 12) this noise, e.g., based on the recorded noise and/or based on a library of known sounds/noises, which may, for example, improve the quality of voice recordings from user 14 and/or the accuracy of STT engine 42. In some embodiments, the head worn device 12 may be configurable to monitor the pressure in one or more components of voice recognition system 10, e.g., in a SCBA by user 14. In some embodiments, the head worn device 12 may activate voice recognition (e.g., may begin listening for voice commands from user 14) in response to the monitored pressure falling below a threshold/setpoint/alarm point.

In some embodiments, head worn device 12 (e.g., using intent determiner 44), may be configured to execute one or more of the following procedures based on voice commands and/or button presses received from user 14:
Toggle feature functionality;
Toggle voice activated (VOX)/Push to Talk (PTT) functionality;
Audio recording (e.g., toggle on/off);
Video recording (e.g., toggle on/off);
Take snapshot picture (e.g., using image sensor 31);
Display (e.g., toggle on/off display 22);
Display dimming feature (e.g., cycling through brightness levels of display 22);
Thermal Imaging Camera (TIC) Display (e.g., toggle on/off image sensor 31 thermal imaging functionality);
Heads up display (HUD) functions, such as icons/LEDs indicating air pressure level, SCBA status and telemetry, etc. (e.g., as displayed on display 22);
Toggle TIC views, e.g., between: cross-hair temperature, maximum temperature, hot spot tracker, cold spot tracker, etc.;
Toggle TIC views, e.g., between: Dynamic (Colorization mode), Fixed (Colorization Mode), Greyscale, etc.;
Toggle TIC view display type, e.g., different arrangements of icons, pictures, text, etc. on display 22;
Toggle TIC temperature setting (e.g., Fahrenheit or Celsius);
TIC view (e.g., zoom in/out);
TIC view (e.g., auto rotate on/off);
Toggle TIC/Visible light camera view;
Toggle between cameras/image sensors 31 (e.g., different image sensors 31 pointing front/back/up/down/etc.);
Volume up/down (e.g., speaker 18);
Volume: cycling through volume levels (e.g., of speaker 18);
Mute speaker 18;
Mute microphone 20;
Toggle microphone 20 gain (up/down), cycle through gain levels, etc.;
Toggle noise cancelling (e.g., breath detection) of microphone 20;
Pause command;
Initiate voice command(s);
Activate near field communication (NFC);
Activate Bluetooth;
Activate WiFi;
Display or play audio of battery status;
Display or play audio of air pressure level;
Display or play audio of Team Members in mesh network
Bluetooth pairing;
Change radio channel;
Toggle between Bluetooth profile types;
Toggle sleep mode;
Toggle on/off mesh network/Crew Talk functionality;
Toggle audio connection priority;
Toggle audio filters;
Change transmit power levels (e.g., of communication interface 33, etc.);
Toggle mesh network/Crew Talk modes: Team Leader, Team Member, Unsubscribed, or listen only, etc.;
Toggle radio direct interface (RDI) audio path to transmit through a mesh network system;
Acknowledgement (from external request);
Enable/disable haptic commands (e.g., from haptic feedback generator 30);
Mute All/Quiet Mode (e.g., mute all speaker(s) 18 and microphone(s) 20);
On/Off bone conduction headset/bone conduction headphone (BCH) vibrate alert;
Toggle Air Pressure (PSI, BAR, etc.) indication on display 22;
Toggle distress alarm (on/off) (e.g., Personal Alert Safety System (PASS) alarm, distress signal unit alarm, man down alarm, etc.); and/or
Self-initiated evacuation command (e.g., toggle a self-evacuation mode, in which first responder initiates evacuation procedure on his or her own volition, and/or provide the user, such as an incident commander, with a notification that another first responder in the vicinity has toggled the self-initiated evacuation mode).

It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings.

1. A head worn device configured to be worn by a user, the head worn device including at least one microphone and processing circuitry in communication with the at least one microphone, the processing circuitry being configured to:
receive an audio signal detected by the at least one microphone, the audio signal representing the user's speech;
evaluate the received audio signal and determine at least one intent based on the received audio signal, the evaluating and determining being performed by the processing circuitry; and
perform at least one action based on the determined intent.

2. The head worn device of claim 1, wherein the head worn device includes a mechanical barrier, the mechanical barrier defining a cavity including the at least one microphone and the user's mouth when head worn device is worn by user, the mechanical barrier being configured to attenuate noise originating from outside the cavity.

3. A method implemented by a head worn device configured to be worn by a user, the head worn device including at least one microphone and processing circuitry in communication with the at least one microphone, the method including:
receiving an audio signal detected by the at least one microphone, the audio signal representing the user's speech;
evaluating the received audio signal and determining at least one intent based on the received audio signal, the evaluating and determining being performed by the processing circuitry; and
performing at least one action based on the determined intent.

4. The method of claim 3, wherein the head worn device includes a mechanical barrier, the mechanical barrier defining a cavity including the at least one microphone and the user's mouth when head worn device is worn by user, the mechanical barrier being configured to attenuate noise originating from outside the cavity.
